(19) United States
(12) Patent Application Publication
(10) Pub. No.: US 2024/0345886 A1
(43) Pub. Date: Oct. 17, 2024

(54) SUSPENSION OF RELATED RESOURCES MONITORING DURING MAINTENANCE

(71) Applicant: VMWARE, INC., Palo Alto, CA (US)

(72) Inventors: Padmini Sampige THIRUMALACHAR, Bangalore (IN); Smeeth VIRPARIYA, Bangalore (IN); Vaghinak SAGHATELYAN, Yerevan (AM); Bhanukiran KARANAM, Bangalore (IN)

(21) Appl. No.: 18/207,209

(22) Filed: Jun. 8, 2023

(30) Foreign Application Priority Data
Apr. 11, 2023 (IN) 202341026798

(51) Int. Cl. G06F 9/50

(52) U.S. Cl. CPC G06F 9/5038; G06F 9/5077; G06F 9/541

(57) ABSTRACT

An example a management node may include a processor and memory coupled to the processor. The memory may include a resource management module to determine a maintenance schedule of a resource in a data center. Prior to the resource entering the maintenance schedule, the resource management module may determine a set of resources having a dependency relationship with the resource based on a preselected category. During the maintenance schedule of the resource, the resource management module may mark that the resource and the set of resources having the dependency relationship with the resource are in a maintenance mode. Upon marking the resource and the set of resources, the resource management module may suspend monitoring of the resource and the set of resources.

### RELATED APPLICATION

Benefit is claimed under 35 U.S.C. 119 (a)-(d) to Foreign application Ser. No. 202341026798 filed in India entitled “SUSPENSION OF RELATED RESOURCES MONITORING DURING MAINTENANCE”, on Apr. 11, 2023 by VMware, Inc., which is herein incorporated in its entirety by reference for all purposes.

### TECHNICAL FIELD

The present disclosure relates to computing environments, and more particularly to methods, techniques, and systems for suspending monitoring of related resources of a resource during maintenance of the resource.

### BACKGROUND

In application/operating system (OS) monitoring environments, a management node that runs a monitoring tool (i.e., a monitoring application) may communicate with multiple resources (i.e., endpoints) to monitor the resources. For example, a resource may be implemented in a physical computing environment, a virtual computing environment, or a cloud computing environment. Further, the resources may execute different applications via virtual machines (VMs), physical host computing systems, containers, and the like. In such environments, the management node may communicate with the resources to collect performance data/metrics (e.g., application metrics, operating system metrics, and the like) from underlying operating system and/or services on the resources for storage and performance analysis (e.g., to detect and diagnose issues). In some examples, a resource (e.g., an infrastructure/application) may be taken off the grid for maintenance (e.g., bringing down the infrastructure/application for patching, upgrading, or regular servicing). Further, during the maintenance mode of the resource, monitoring of the resource may have to be suspended, for instance, to avoid any false alerts.

### BRIEF DESCRIPTION OF THE DRAWINGS

FIG. 1 is a block diagram of an example system, depicting a resource management module to mark a set of resources having a dependency relationship with a resource as in a maintenance mode;

FIG. 2 is a flow diagram illustrating an example method for marking a resource and a set of resources dependent on the resource as in a maintenance mode;

FIG. 3A is a flow diagram illustrating another example method for marking a resource and a set of resources dependent on the resource as in a maintenance mode when the resource is entering a maintenance schedule;

FIG. 3B is a flow diagram illustrating an example method for unmarking the resource and the set of resources dependent on the resource from the maintenance mode when the resource is exiting the maintenance schedule;

FIG. 4A is a flow diagram illustrating an example method for marking an infrastructure resource and a set of resources dependent on the infrastructure resource as in a maintenance mode;

FIG. 4B is a flow diagram illustrating an example method for marking a business application and a set of resources dependent on the business application as in a maintenance mode;

FIG. 5A shows an example graphical user interface of a performance monitoring tool depicting managing maintenance schedules of a resource;

FIG. 5B shows an example graphical user interface of the performance monitoring tool of FIG. 5A depicting related resources of the resource;

FIG. 5C shows an example graphical user interface of the performance monitoring tool of FIG. 5A depicting a metric collection status of a resource and related resources;

FIG. 6A shows an example graphical user interface of a performance monitoring tool depicting managing a maintenance schedule of a business application;

FIG. 6B shows an example graphical user interface of the performance monitoring tool of FIG. 6A depicting related applications of the business application;

FIG. 6C shows an example graphical user interface of the performance monitoring tool of FIG. 6A depicting a collection status of the business application and related applications; and

FIG. 7 is a block diagram of an example management node including non-transitory computer-readable storage medium storing instructions to suspend monitoring of a resource and a set of resources having a dependency relationship with the resource during maintenance mode.

The drawings described herein are for illustrative purposes and are not intended to limit the scope of the present subject matter in any way.

### DETAILED DESCRIPTION

Examples described herein may provide an enhanced computer-based and/or network-based method, technique, and system to suspend monitoring of resources having a dependency relationship with a resource during the maintenance of the resource in a computing environment. The paragraphs to present an overview of the computing environment, existing methods to suspend monitoring of the resources during maintenance, and drawbacks associated with the existing methods.

The computing environment may be a virtual computing environment (e.g., a cloud computing environment, a virtualized environment, and the like). The virtual computing environment may be a pool or collection of cloud infrastructure resources designed for enterprise needs. The resources may be a processor (e.g., central processing unit (CPU)), memory (e.g., random-access memory (RAM)), storage (e.g., disk space), and networking (e.g., bandwidth). Further, the virtual computing environment may be a virtual representation of the physical data center, complete with servers, storage clusters, and networking components, all of which may reside in virtual space being hosted by one or more physical data centers. The virtual computing environment may include multiple physical computers (e.g., servers) executing different computing-instances or workloads (e.g., virtual machines, containers, and the like). The workloads may execute different types of applications or software products. Thus, the resource can be one of an infrastructure element and a business application, such as physical host computing systems, virtual machines, software defined data centers (SDDCs), containers, business applications, and/or the like.

Further, performance monitoring of such resources has become increasingly important because performance monitoring may aid in troubleshooting (e.g., to rectify abnormalities or shortcomings, if any) the resources, provide better health of data centers, analyse the cost, capacity, and/or the like. An example performance monitoring tool or application or platform may be VMware® vRealize Operations (vROps), VMware Wavefront™, Grafana, and the like.

In some examples, the resources may include monitoring agents (e.g., Telegraf™, Collectd, Micrometer, and the like) to collect the performance metrics from the respective resources and provide, via a network, the collected performance metrics to a remote collector (e.g., a Cloud Proxy (CP)). Further, the monitoring application may receive the performance metrics from the remote collector, analyse the received performance metrics, and display the analysis in a form of dashboards, for instance. The displayed analysis may facilitate in visualizing the performance metrics and diagnose a root cause of issues, if any.

Thus, the performance monitoring tools, such as vROps, support application and operating system operations and management by providing insights into the health of business applications, the health of the infrastructure element, and the like. In some example scenarios, the resources such as the infrastructure element and/or the business application may have to be taken off the grid for maintenance, i.e., to bring down the infrastructure element and/or the business application for patching, upgrading, regular servicing, and the like. In this example scenario, to avoid any false alerts during the maintenance, a virtual infrastructure administrator and/or application administrator may schedule this duration as a maintenance window and select the resources which are going into the maintenance mode. Thus, monitoring the selected resources and alerting based on the monitoring do not flag as “infrastructure element/business application down”, which is a false positive.

In some existing methods, each resource entering the maintenance mode may have to be individually selected by the administrator. Manual selection of the resources may not be feasible when multiple related resources have to be selected for the maintenance mode. For example, consider that a user needs to bring down a host computing system (e.g., ESXi host) for regular maintenance. Further, consider that the ESXi host may house multiple virtual machines and these virtual machines may be hosting multiple workload applications. When the ESXi host is switched off for regular maintenance, the virtual machines and the applications may also be not available. To ensure that the virtual machines and the applications do not show false alerts (e.g., of virtual machines/applications being down), the user may have to mark all the related resources to be in the maintenance mode, which is a manual process. For example, the user may have to determine the related resources from a dependency hierarchy (i.e., parent/ancestor object) and mark the related resources into the maintenance mode.

In other examples, consider that the resource is a business application, which may be made up of a Web tier and a database tier. In this example, the roles and responsibilities of teams may be assigned, and the teams that work on the applications may have access and permission to the tier they are responsible. For example, the applications team may be only responsible for the Web tier and the database team may be responsible for the database tier. Further, a server team may be responsible for underlying infrastructure. When a database of the database tier includes an issue (e.g., an issue with a hosted application and needs to be down, i.e., for a couple of hours). To achieve this, the database team may have to communicate with the server team to bring down the database. Further, the server team may have to identify if there are any business application associated with the database and mark the associated applications and the business application in maintenance mode in order to ensure that there are no false alerts on the Web tier and the associated business applications. In the existing method, marking the database and the related business application may be performed manually. For example, the administrator may determine the related resources looking at the relationship hierarchy and mark each resource one by one as in the maintenance mode. With manual selection of the resources, the chances of missing out the resources may be significantly high. Also, the manual process may be time consuming and error prone.

In addition, the maintenance mode can be scheduled for a particular time. In some example scenarios, new child/descendent resources may get discovered before the maintenance schedule. In this example, marking the new resources for the maintenance mode may not be feasible and thus the new resources may not be considered for the downtime. Therefore, there may be a chance of false positives corresponding to the new resources during the maintenance schedule. Such false positives may lead to unnecessary waste of effort, time, and money on a non-existent issue.

Examples described herein may provide a resource management module to suspend monitoring of a resource and a set of resources having a dependency relationship with the resource during a maintenance mode. In an example, a management node may include a processor and memory coupled to the processor. In an example, the memory may include a resource management module. During operation, the resource management module may determine a maintenance schedule of a resource in a data center. Prior to the resource entering the maintenance schedule, the resource management module may determine a set of resources having a dependency relationship with the resource based on a preselected category. During the maintenance schedule of the resource, the resource management module may mark that the resource and the set of resources having the dependency relationship with the resource are in a maintenance mode. Upon marking the resource and the set of resources, the resource management module may suspend monitoring of the resource and the set of resources.

Examples described herein may automatically mark the related resources as in the maintenance mode. Also, examples described herein may provide an option to selectively choose the category (e.g., descendants, ancestors and/or peer of the resource-kind) of the set of resources having dependency relationship with the resource to be marked as in the maintenance mode. Thus, examples described herein may simplify/ease the usage of the performance monitoring tool by removing manual effort and thereby removing the associated errors. Also, examples described herein may significantly save time, effort, and money by removing the false positives.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

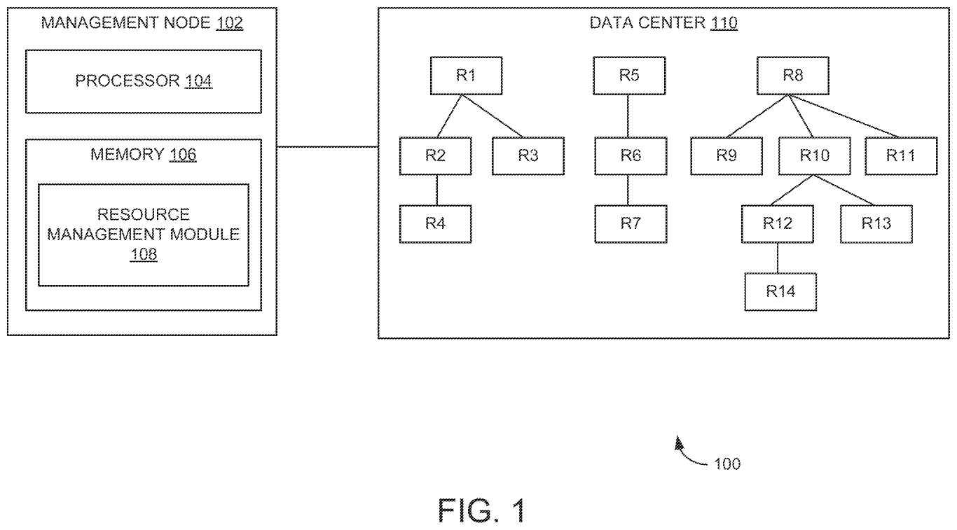

Referring now to the figures, FIG. 1 is a block diagram of an example system 100, depicting a resource management module 108 to mark a set of resources having a dependency relationship with a resource as in a maintenance mode. Example system 100 may include a computing environment such as a cloud computing environment (e.g., a virtualized cloud computing environment), a physical computing environment, or a combination thereof. For example, the cloud computing environment may be enabled by vSphere®, VMware's cloud computing virtualization platform. The cloud computing environment may include one or more computing platforms that support the creation, deployment, and management of virtual machine-based cloud applications or services or programs. An application, also referred to as an application program, may be a computer software package that performs a specific function directly for an end user or, in some cases, for another application. Examples of applications may include MySQL, Tomcat, Apache, word processors, database programs, web browsers, development tools, image editors, communication platforms, and the like.

As shown in FIG. 1, example system 100 include a data center 110 having multiple resources (e.g., R1 to R14). In an example, a resource may include one of an infrastructure element and a business application. For example, the resource may include, but not limited to, a virtual machine, a physical host computing system, a container, a software defined data center (SDDC), or any other computing instance that executes different applications. Further, the resource can be deployed either in an on-premises platform or an off-premises platform (e.g., a cloud managed SDDC). An SDDC may refer to a data center where infrastructure is virtualized through abstraction, resource pooling, and automation to deliver Infrastructure-as-a-service (IAAS). Further, the SDDC may include various components such as a host computing system, a virtual machine, a container, or any combinations thereof. Example host computing system may be a physical computer. The physical computer may be a hardware-based device (e.g., a personal computer, a laptop, or the like) including an operating system (OS). The virtual machine may operate with its own guest operating system on the physical computer using resources of the physical computer virtualized by virtualization software (e.g., a hypervisor, a virtual machine monitor, and the like). The container may be a data computer node that runs on top of host operating system without the need for the hypervisor or separate operating system.

In some examples, the resources (e.g., R1 to R14) may include a monitoring agent to monitor applications or services or programs. The monitoring agent may be installed in the resources to fetch the metrics from various components of the resources. For example, the monitoring agent may real-time monitor R1 to collect the metrics (e.g., telemetry data) associated with an application or an operating system running in R1. An example monitoring agent may be Telegraf agent, Collectd agent, or the like. Example metrics may include performance metric values associated with at least one of central processing unit (CPU), memory, storage, graphics, network traffic, or the like. Further, the monitoring agent may send the performance metrics to a performance monitoring tool (e.g., VMware® vRealize Operations (vROps), VMware Wavefront™, Grafana, and the like) via a remote collector (e.g., a Cloud Proxy (CP)). Further, the performance monitoring tool may analyse the received performance metrics and display the analysis in a form of dashboards, for instance. The displayed analysis may facilitate in visualizing the performance metrics and diagnose a root cause of issues, if any.

As shown in FIG. 1, system 100 may include a management node 102 communicatively connected to data center 110 via a network. An example network can be a managed Internet protocol (IP) network administered by a service provider. For example, the network may be implemented using wireless protocols and technologies, such as Wi-Fi, WiMAX, and the like. In other examples, the network can also be a packet-switched network such as a local area network, wide area network, metropolitan area network, Internet network, or other similar type of network environment. In yet other examples, the network may be a fixed wireless network, a wireless local area network (LAN), a wireless wide area network (WAN), a personal area network (PAN), a virtual private network (VPN), intranet or other suitable network system and includes equipment for receiving and transmitting signals.

As shown in FIG. 1, management node 102 may include a processor 104. Processor 104 may refer to, for example, a central processing unit (CPU), a semiconductor-based microprocessor, a digital signal processor (DSP) such as a digital image processing unit, or other hardware devices or processing elements suitable to retrieve and execute instructions stored in a storage medium, or suitable combinations thereof. Processor 104 may, for example, include single or multiple cores on a chip, multiple cores across multiple chips, multiple cores across multiple devices, or suitable combinations thereof. Processor 104 may be functional to fetch, decode, and execute instructions as described herein. Further, management node 102 includes memory 106 coupled to processor 104. In an example, memory 106 includes resource management module 108.

During operation, resource management module 108 may determine a maintenance schedule of a resource (e.g., R10) in data center 110. In an example, an administrator may schedule the maintenance schedule to bring down resource R10 for patching, upgrading, regular servicing, and the like. Further, prior to the resource R10 entering the maintenance schedule, resource management module 108 may determine a set of resources having a dependency relationship with the resource R10 based on a preselected category.

In an example, resource management module 108 may receive, via an interface, a selection of an option specifying the preselected category of resources (e.g., ancestors, descendants, or peers of resource-type) to be placed in the maintenance mode. For example, a descendant resource may refer to a resource type that is at any level below the base resource type, either a direct or indirect child object. For example, a virtual machine is a descendant of a host computing system (e.g., ESXi). An ancestor resource may refer to a resource type that is one or more levels higher than the base resource type, either a direct or indirect parent. For example, a data center and a vCenter Server are ancestors of a host computing system. The parent may refer to a resource type that is in an immediately higher level in the hierarchy from the base resource type. For example, a data center is a parent of the host computing system. The child may refer to a resource type that is one level below the base resource type. For example, a virtual machine is a child of a host computing system. A peer resource of a resource-type may refer to a resource that provides the same functionality as the base resource type. For example, a cluster may include multiple host computing systems having a similar functionality as peers.

The preselected category of resources may specify a type of the dependency relationship with the resource. For example, when resource R10 is the infrastructure element, resource management module 108 may determine the set of resources that are descendants (e.g., R12, R13, and R14) of resource R10, ancestors (e.g., R8) of the resource (e.g., R10), peers of a resource-type (e.g., R9 and R11) associated with resource R10, or any combination thereof based on the preselected category. In another example, when resource R10 is the business application, resource management module 108 may determine the set of resources that are descendants (e.g., R12, R13, and R14) of resource R10, ancestors (e.g., R8) of resource R10, or both based on the preselected category.

During the maintenance schedule of resource R10, resource management module 108 may mark that resource R10 and the set of resources having the dependency relationship with resource R10 are in a maintenance mode. For example, when the preselected category includes ancestors, then resource R8 along with resource R10 may be placed in the maintenance mode. when the preselected category includes descendants, then resources R12, R13, and R14 along with resource R10 may be placed in the maintenance mode. Further, resource management module 108 may update an interface to indicate that resource R10 and the determined set of resources (e.g., R12, R13, and R14 when the preselected category specifies descendants) are in the maintenance mode. For example, the interface may include a user interface, an application programming interface (API), and a Representational State Transfer (REST) API, or any combination thereof. An example user interface may include a Web browser.

Upon marking resource R10 and the set of resources (e.g., R12, R13, and R14), resource management module 108 may suspend monitoring of resource R10 and the set of resources (e.g., R12, R13, and R14). For example, resource management module 108 may suspend computation of health, alerts, troubleshooting workbench, reports, and predefined dashboards for resource R10 and the determined set of resources (e.g., R12, R13, and R14) to avoid generation of false alerts during the scheduled maintenance. The troubleshooting workbench may provide the user with a framework around which the user can troubleshoot problems (e.g., errors).

In some examples, the functionalities described in FIG. 1, in relation to instructions to implement functions of resource management module 108 and any additional instructions described herein in relation to the storage medium, may be implemented as engines or modules including any combination of hardware and programming to implement the functionalities of the modules or engines described herein. The functions of resource management module 108 may also be implemented by a processor. In examples described herein, the processor may include, for example, one processor or multiple processors included in a single device or distributed across multiple devices.

Further, the cloud computing environment illustrated in FIG. 1 is shown purely for purposes of illustration and is not intended to be in any way inclusive or limiting to the embodiments that are described herein. For example, a typical cloud computing environment would include many more remote servers (e.g., resources), which may be distributed over multiple data centers, which might include many other types of devices, such as switches, power supplies, cooling systems, environmental controls, and the like, which are not illustrated herein. It will be apparent to one of ordinary skill in the art that the example shown in FIG. 1, as well as all other figures in this disclosure have been simplified for ease of understanding and are not intended to be exhaustive or limiting to the scope of the idea.

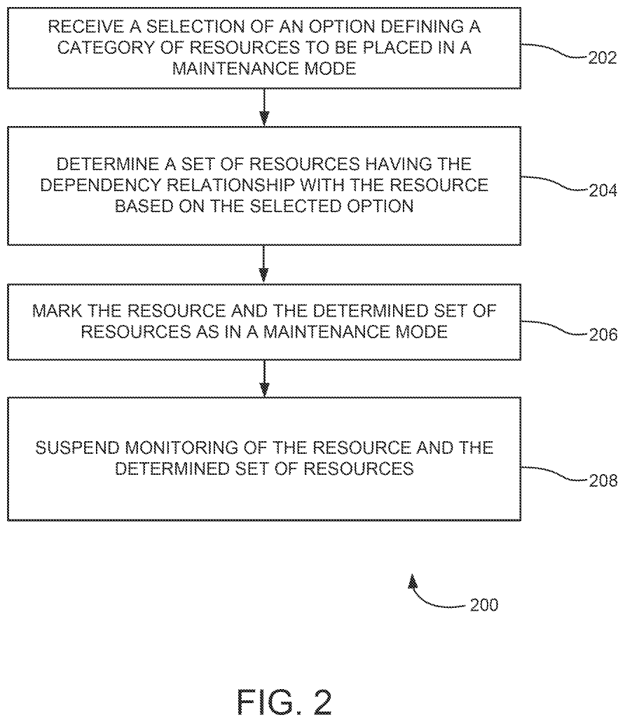

FIG. 2 is a flow diagram illustrating an example method 200 for marking a resource and a set of resources dependent on the resource as in a maintenance mode. At 202, a selection of an option defining a category of resources to be placed in a maintenance mode may be received via an interface. In an example, the category of resources may specify a dependency relationship with a resource in a data center. An example category of resources may include descendants of the resource, ancestors of the resource, peers of resource-type associated with the resource, or any combination thereof. In an example, the resource may include an infrastructure element in a data center. In another example, the resource may include a business application.

During a scheduled maintenance of the resource, at 204, a set of resources having the dependency relationship with the resource may be determined based on the selected option. For example, when the resource is the infrastructure element, then the set of resources may include at least one virtual machine running on a physical host computing system, at least one application running on the at least one virtual machine or the physical host computing system, and the like. In another example, when the resource is the business application, then the set of resources may include components of the business application that provide a business functionality.

At 206, the resource and the determined set of resources may be marked as in a maintenance mode. In an example, the interface may be updated to indicate that the resource and the determined set of resources are in maintenance mode. An example interface includes a user interface, an application programming interface (API), and a Representational State Transfer (REST) API, or any combination thereof. An example user interface includes a Web browser.

Upon marking the resource and the determined set of resources, at 208, monitoring of the resource and the determined set of resources having the dependency relationship with the resource may be suspended. In an example, suspending monitoring of the resource and the determined set of resources may include suspending computation of health, alerts, troubleshooting workbench, reports, and predefined dashboards for the resource and the determined set of resources. Further, suspending monitoring of the resource and the determined set of resources may avoid generating false positive alerts during the scheduled maintenance.

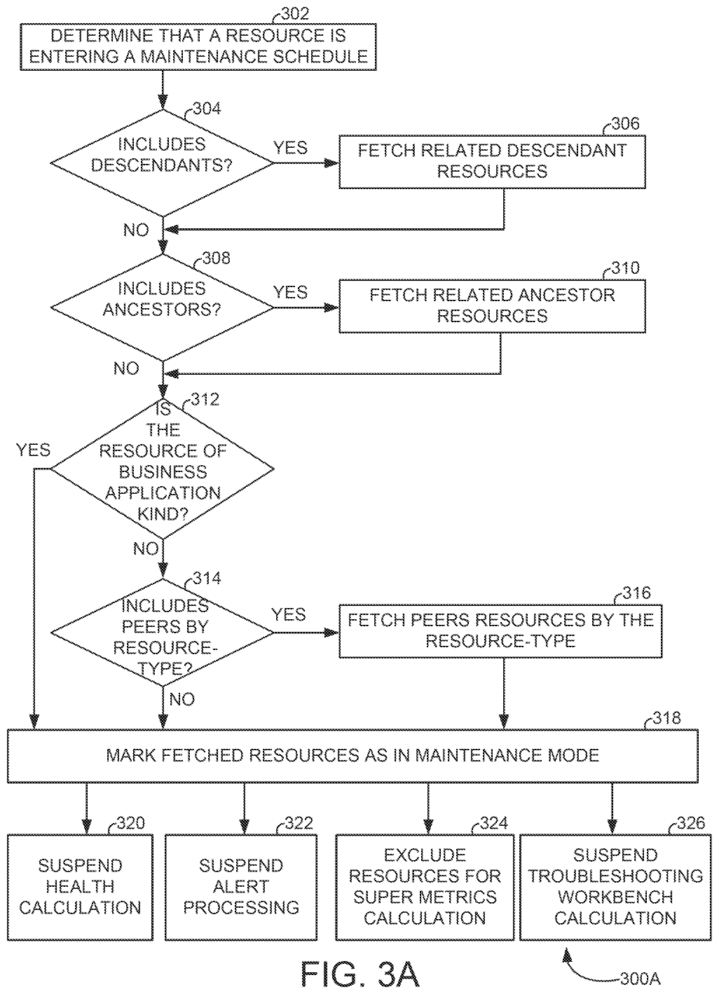

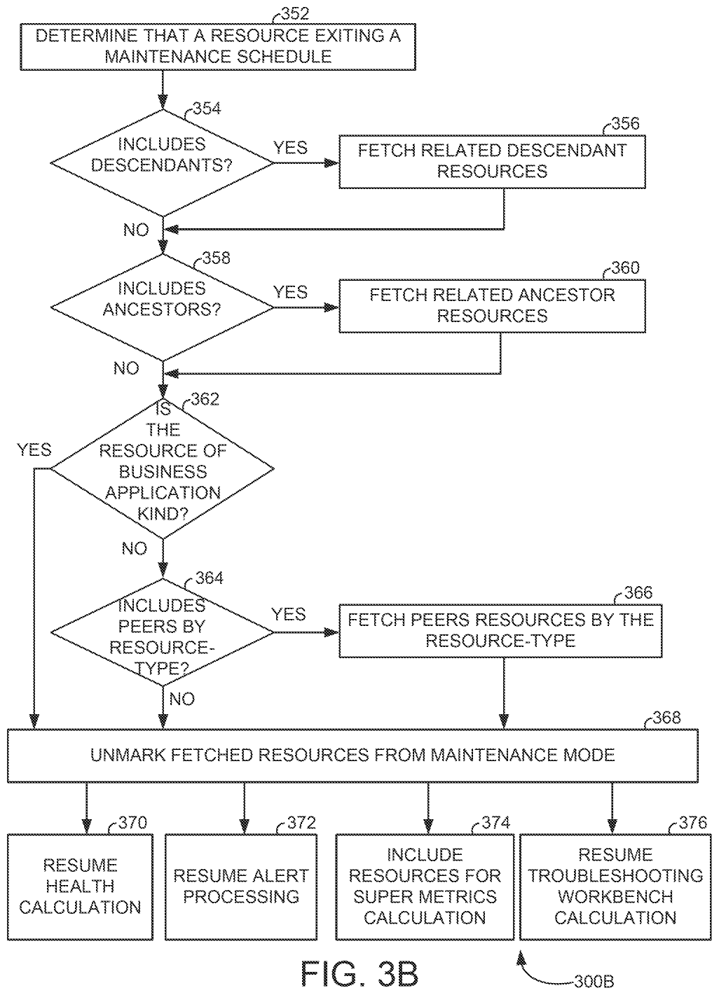

FIG. 3A is a flow diagram illustrating another example method 300A for marking a resource and a set of resources dependent on the resource as in a maintenance mode when the resource is entering a maintenance schedule. In an example, an administrator may schedule the maintenance of the resource to bring down the resource for patching, upgrading, regular servicing, and the like. During such maintenance schedule, the resource may be marked as in the maintenance mode. In an example, a user interface may be provided for a user to select a category of the resources to be marked as in a maintenance mode when the resource enters the maintenance schedule. An example category may be descendants of the resource, ancestors of the resource, peers of a resource-type associated with the resource, and the like based on type of the resource (e.g., an infrastructure element, a business application, and the like).

An ascendant resource may refer to any object higher in the “tree”, for instance includes parent, grandparent, great-grandparent, and the like. The parent may refer to an object directly above the selected object (e.g., VM's parent is a host, Host parent is a cluster, and the like). A descendant resource may refer to any object lower in the “tree”, for instance includes child, grandchild, great-grandchild, and the like. The child may refer to an object directly below the selected object in the “tree” (e.g., host child is any VM on the host).

At 302, a resource entering the maintenance schedule may be determined or detected based on a maintenance scheduled by the administrator. At 304, a check may be made to determine whether related descendant resources associated with the resource has to be included based on the user selected category. When the user selected category includes the descendants of the resource, then the related descendant resources of the resource may be fetched, at 306.

When the user selected category does not include the descendant category or upon fetching the descendant resources at 306, a check may be made to determine whether related ancestor resources associated with the resource has to be included based on the user selected category, at 308. When the user selected category includes the ancestors of the resource, then the related ancestor resources of the resource may be fetched, at 310.

When the user selected category does not include the ancestor category or upon fetching the ancestor resources at 310, a check may be made to determine whether the resource is of a business application kind, at 312. When the resource is not of the business application kind (i.e., When the resource is an infrastructure resource), a check may be made to determine whether related peer resource-type associated with the resource has to be included based on the user selected category, at 314. When the user selected category includes the peer resource-type of the resource, then the peer resources by the resource-type of the resource may be fetched, at 316. For example, when the resource entering the maintenance schedule is a ESXi host, then the peer resources by the resource-type may refer to other ESXi hosts that are dependent on the ESXi host.

Further, when the resource is of the business application kind at 312, when the user selected category does not include the peer resource-type at 314, or upon fetching the peer resources at 316, all the fetched resources may be marked as in the maintenance mode, at 318. Thus, the related descendant resources, ancestor resources and/or peer resources of the resource-type associated with the resource may be dynamically detected based on the selected category. Further, the resource and the related resource may be marked as “in maintenance” mode. Upon marking the resources as in the maintenance mode, health calculation may be suspended (e.g., at 320), an alert processing may be suspended (e.g., at 322), super metrics calculation may be excluded for the marked resources (e.g., at 324), and troubleshooting workbench calculation of the marked resources may be suspended (e.g., at 326). Thus, such suspensions during the “maintenance window” ensures that false positives do not get generated.

FIG. 3B is a flow diagram illustrating an example method 300B for unmarking the resource and the set of resources dependent on the resource from the maintenance mode when the resource is exiting the maintenance schedule. At 352, a resource exiting the maintenance schedule may be determined or detected. At 354, a check may be made to determine whether related descendant resources associated with the resource are included in the maintenance mode based on the user selected category. When the user selected category includes the descendants of the resource, then the related descendant resources of the resource may be fetched, at 356.

When the user selected category does not include the descendant category or upon fetching the descendant resources at 356, a check may be made to determine whether related ancestor resources associated with the resource are in the maintenance mode based on the user selected category, at 358. When the user selected category includes the ancestors of the resource, then the related ancestor resources of the resource may be fetched, at 360.

When the user selected category does not include the ancestor category or upon fetching the ancestor resources at 360, a check may be made to determine whether the resource is of a business application kind, at 362. When the resource is not of the business application kind (i.e., When the resource is an infrastructure resource), a check may be made to determine whether related peer resource-type associated with the resource are included in the maintenance mode based on the user selected category, at 364. When the user selected category includes the peer resource-type of the resource, then the peer resources by the resource-type of the resource may be fetched, at 366.

Further, when the resource is of the business application kind, when the user selected category does not include the peer resource-type, or upon fetching the peer resources at 366, all the fetched resources may be unmarked from the maintenance mode, at 368. Upon unmarking the resources from the maintenance mode, health calculation may be resumed (e.g., at 370), an alert processing may be resumed (e.g., at 372), super metrics calculation may be included for the unmarked resources (e.g., at 374), and troubleshooting workbench calculation of the unmarked resources may be resumed (e.g., at 376).

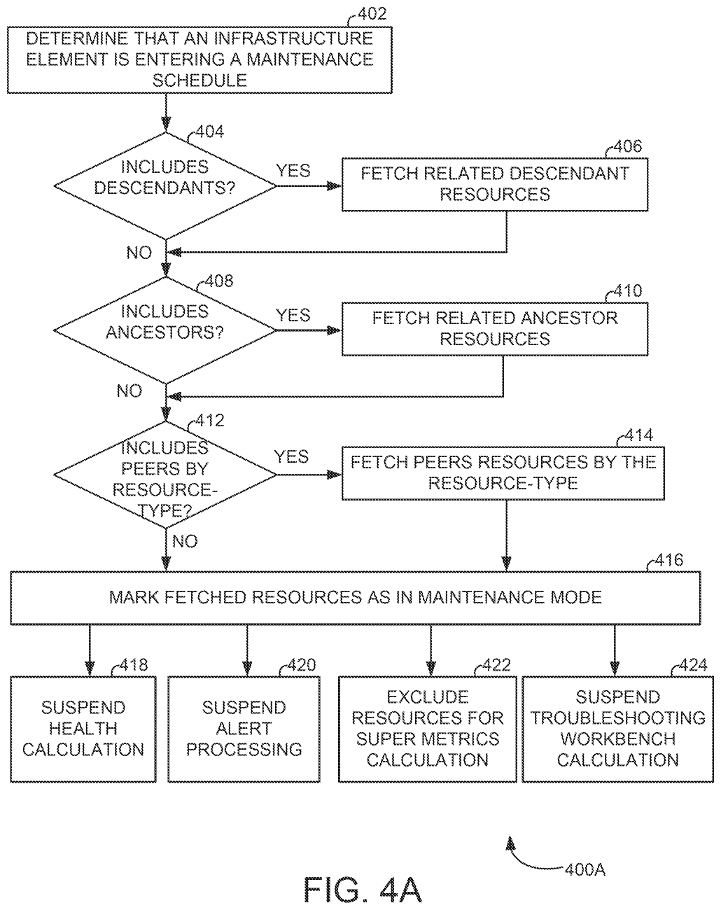

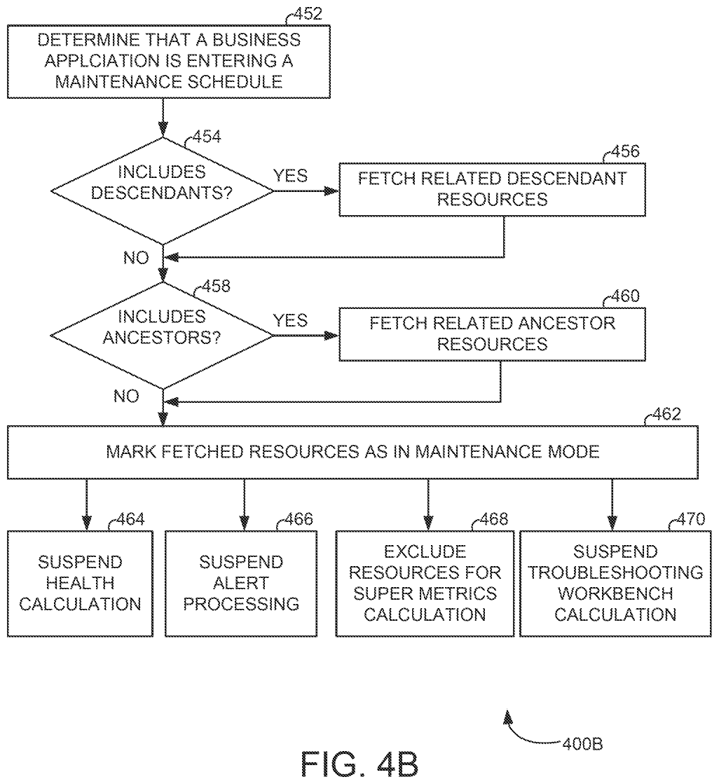

FIG. 4A is a flow diagram illustrating an example method 400A for marking an infrastructure resource and a set of resources dependent on the infrastructure resource as in a maintenance mode. At 402, the infrastructure resource entering a maintenance schedule may be determined or detected. At 404, a check may be made to determine whether related descendant resources associated with the infrastructure resource has to be included based on a user selected category. When the user selected category includes the descendants of the resource, then the related descendant resources of the infrastructure resource may be fetched, at 406.

When the user selected category does not include the descendant category or upon fetching the descendant resources at 406, a check may be made to determine whether related ancestor resources associated with the infrastructure resource has to be included based on the user selected category, at 408. When the user selected category includes the ancestors of the resource, then the related ancestor resources of the infrastructure resource may be fetched, at 410.

When the user selected category does not include the ancestor category or upon fetching the ancestor resources at 410, a check may be made to determine whether related peer resource-type associated with the resource has to be included based on the user selected category, at 412. When the user selected category includes the peer resource-type of the infrastructure resource, then the peer resources by the resource-type of the infrastructure resource may be fetched, at 414.

Further, when the user selected category does not include the peer resource-type or upon fetching the peer resources at 414, all the fetched resources may be marked as in the maintenance mode, at 416. Thus, the related descendant resources, ancestor resources and/or peer resource-type associated with the resource may be dynamically detected based on the selected category. Upon marking the resources as in the maintenance mode, health calculation may be suspended (e.g., at 418), an alert processing may be suspended (e.g., at 420), super metrics calculation for the marked resources may be excluded (e.g., at 422), and troubleshooting workbench calculation of the marked resources may be suspended (e.g., at 424).

FIG. 4B is a flow diagram illustrating an example method 400B for marking a business application and a set of resources dependent on the business application as in a maintenance mode. At 452, the business application entering a maintenance schedule may be determined or detected. At 454, a check may be made to determine whether related descendant resources associated with the business application has to be included based on the user selected category. When the user selected category includes the descendants of the business application, then the related descendant resources of the business application may be fetched, at 456.

When the user selected category does not include the descendant category or upon fetching the descendant resources at 456, a check may be made to determine whether related ancestor resources associated with the business application has to be included based on the user selected category, at 458. When the user selected category includes the ancestors of the business application, then the related ancestor resources of the business application may be fetched, at 460.

When the user selected category does not include the ancestor category or upon fetching the ancestor resources at 460, all the fetched resources may be marked as in the maintenance mode, at 462. Thus, the related descendant resources and/or ancestor resources may be dynamically detected based on the selected category. Further, the business application and the related resources may be marked as “in maintenance” mode. Upon marking the resources as in the maintenance mode, health calculation may be suspended (e.g., at 464), an alert processing may be suspended (e.g., at 466), super metrics calculation for the marked resources may be excluded (e.g., at 468), and troubleshooting workbench calculation of the marked resources may be suspended (e.g., at 470).

Example methods 200, 300A, 300B, 400A, and 400B depicted in FIGS. 2, 3A, 3B, 4A, and 4B represent generalized illustrations, and other processes may be added, or existing processes may be removed, modified, or rearranged without departing from the scope and spirit of the present application. In addition, methods 200, 300A, 300B, 400A, and 400B may represent instructions stored on a computer-readable storage medium that, when executed, may cause a processor to respond, to perform actions, to change states, and/or to make decisions. Alternatively, methods 200, 300A, 300B, 400A, and 400B may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but the flow charts illustrate functional information to design/fabricate circuits, generate computer-readable instructions, or use a combination of hardware and computer-readable instructions to perform the illustrated processes.

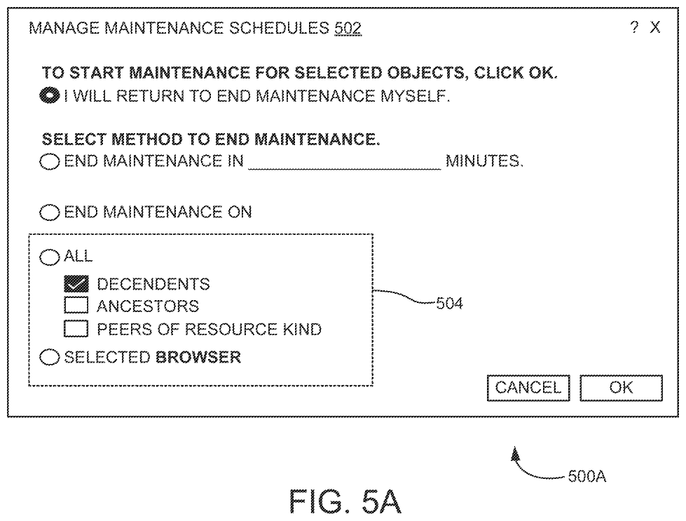

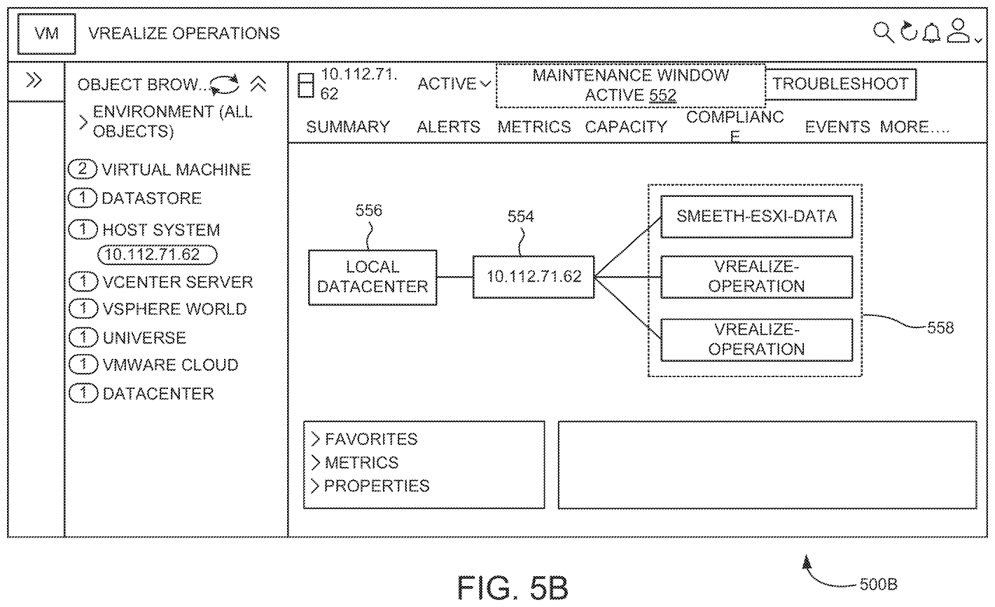

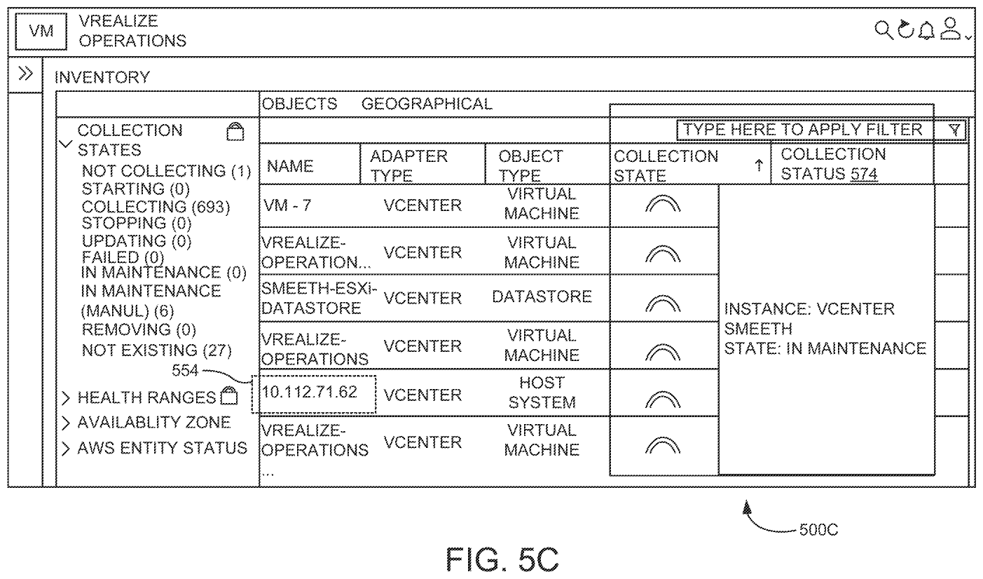

FIG. 5A shows an example graphical user interface 500A of a performance monitoring tool (e.g., vROps) depicting managing maintenance schedules (e.g., 502) of a resource (e.g., an infrastructure element). Example graphical user interface 500A may provide an option 504 for a user to consider descendants of the resource to be included in scheduled maintenance (in some examples, descendants of the resource may be enabled/selected by default), to consider ancestors of the resource to be included in the schedule maintenance, to consider peers for a selected resource-kind, and/or to choose very pointed resource in a relationship hierarchy.

For example, consider the user would like to take off a resource (e.g., ESXi host) for regular maintenance. The ESXi host may include 100 virtual machines which are hosting workload applications. In this example, through graphical user interface 500A, the category of the related resources may be selected. In this example, the descendants may include virtual machines and applications running on the ESXi host and the ancestors may include a host cluster and a data center. In the example graphical user interface 500A, “descendants” may be selected, which indicates that all descendants have to be considered by default for maintenance. Further, during the “maintenance window”, the ESXi and the related virtual machines and application (i.e., the descendent resources) may be marked as “in maintenance”.

FIG. 5B shows an example graphical user interface 500B of the performance monitoring tool of FIG. 5A depicting the related resources of the resource. When a maintenance window or the maintenance schedule of the resource is active (e.g., at 552), an inventory browser may present the related resources on graphical user interface 500B as shown in FIG. 5B. For example, graphical user interface 500B may depict the resource (e.g., 554), associated ancestor resources (e.g., 556), and associated descendant resources (e.g., 558). In an example, when the maintenance window is active (e.g., at 552), the backend may use the relationship tree to determine the descendants of the selected resource, and present on graphical user interface 500B.

FIG. 5C shows an example graphical user interface 500C of the performance monitoring tool of FIG. 5A depicting a metric collection status (e.g., 574) of a resource (e.g., 554) and related resources (e.g., 558). As shown in FIG. 5C, collection status for resource 554 and the descendant resources 558 may be marked as “in maintenance”.

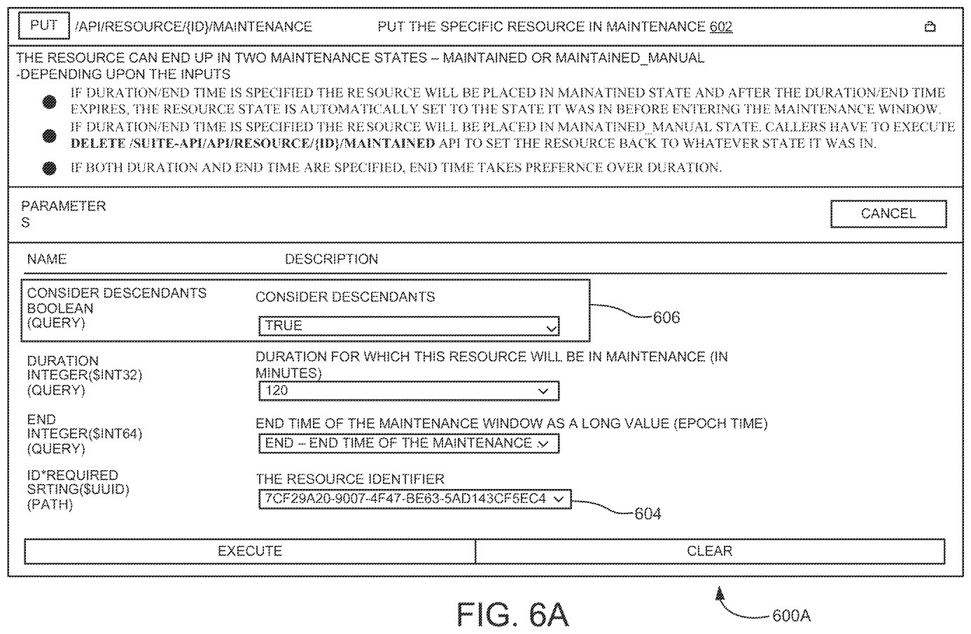

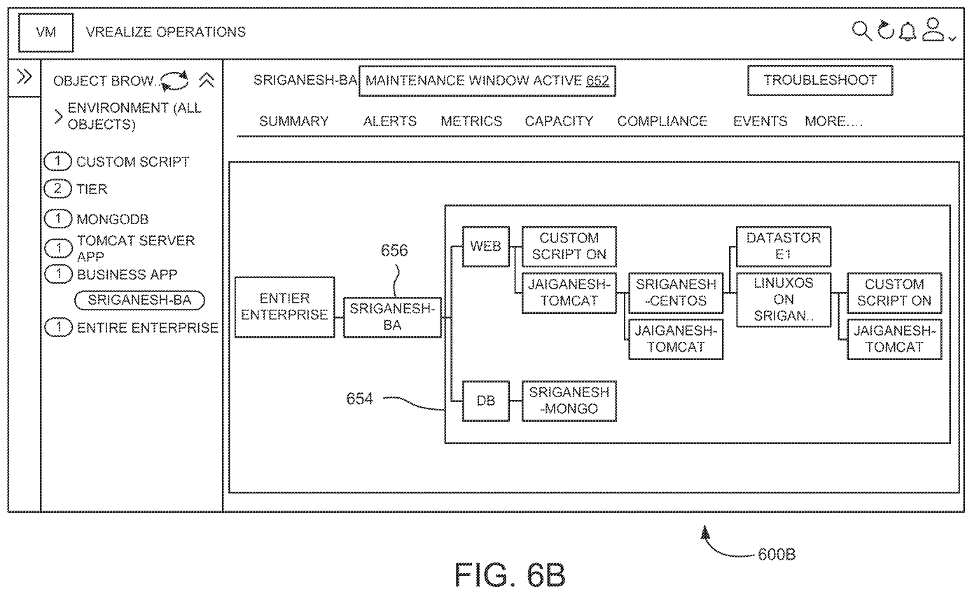

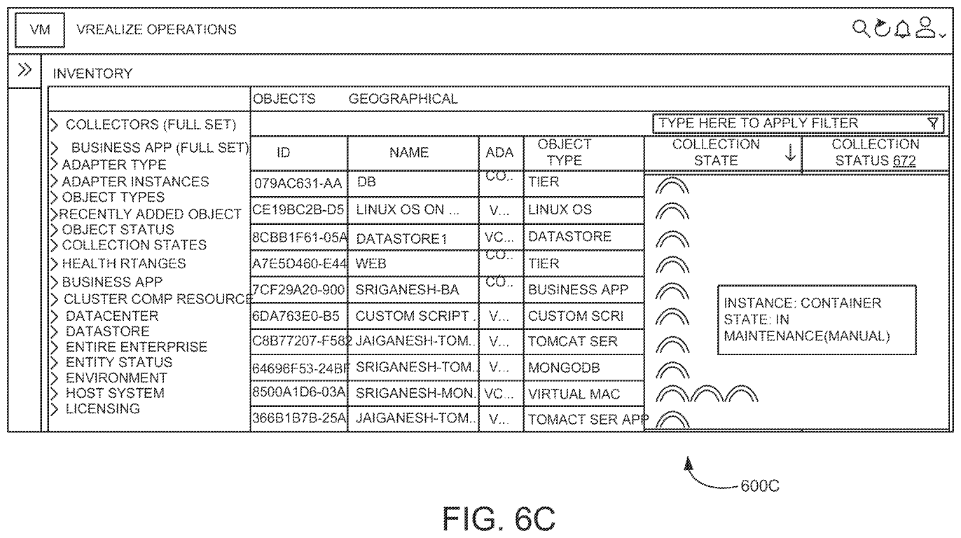

FIG. 6A shows an example graphical user interface 600A of a performance monitoring tool (e.g., vROps) depicting managing a maintenance schedule (e.g., 602) of a business application. For example, a user would like to take off the business application for regular maintenance. The business application may include a Web tier and a database tier. In this example, the user may choose identifier (e.g., 604) of the business application and marks descendant's field (e.g., 606) to true in graphical user interface 600A. Thus, all the applications under the business application and the business application may be put into maintenance mode.

FIG. 6B shows an example graphical user interface 600B of the performance monitoring tool of FIG. 6A depicting the related applications (e.g., 654) of the business application (e.g., 656). When a maintenance window or the maintenance schedule of the business application 656 is active (e.g., 652), an inventory browser may present all the related applications (e.g., 654) on graphical user interface 600B as shown in FIG. 6B.

FIG. 6C shows an example graphical user interface 600C of the performance monitoring tool of FIG. 6A depicting a collection status (e.g., 672) of business application (e.g., 656) and related applications (e.g., 654). As shown in FIG. 6C, collection status 672 for business application 656 and the descendant applications 654 may be marked as “in maintenance”. Thus, examples described herein may provide an ability to the vROps server to support automatic maintenance schedule for relationships of the business application.

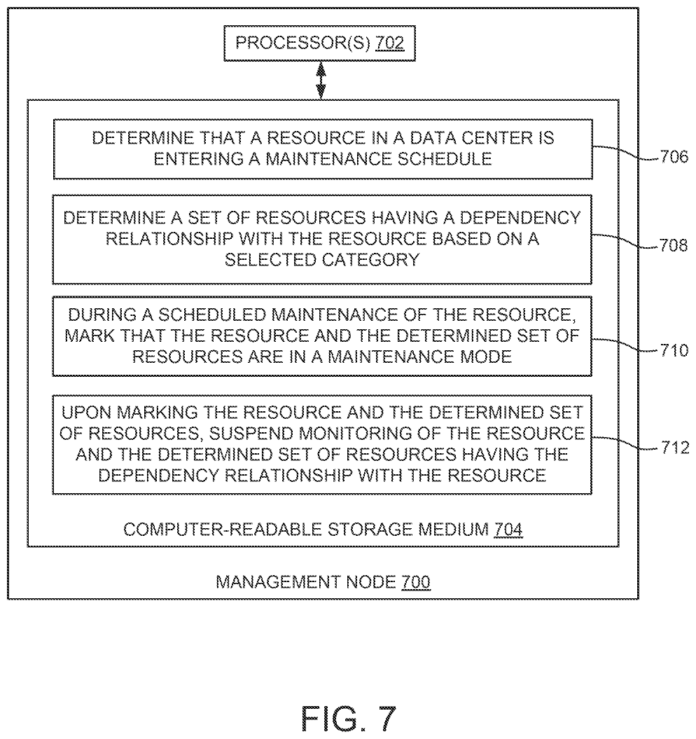

FIG. 7 is a block diagram of an example management node including non-transitory computer-readable storage medium 704 storing instructions to suspend monitoring of a resource and a set of resources having a dependency relationship with the resource during maintenance mode. Management node 700 may include a processor 702 and computer-readable storage medium 704 communicatively coupled through a system bus. Processor 702 may be any type of central processing unit (CPU), microprocessor, or processing logic that interprets and executes computer-readable instructions stored in computer-readable storage medium 704. Computer-readable storage medium 704 may be a random-access memory (RAM) or another type of dynamic storage device that may store information and computer-readable instructions that may be executed by processor 702. For example, computer-readable storage medium 704 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, computer-readable storage medium 704 may be a non-transitory computer-readable medium. In an example, computer-readable storage medium 704 may be remote but accessible to management node 700.

Computer-readable storage medium 704 may store instructions 706, 708, 710, and 712. Instructions 706 may be executed by processor 702 to determine that a resource in a data center is entering a maintenance schedule. In an example, the resource may include one of an infrastructure element and a business application.

Instructions 708 may be executed by processor 702 to determine a set of resources having a dependency relationship with the resource based on a selected category. In an example, computer-readable storage medium 704 may store instructions to receive, via an interface, a selection of a category of resources to be placed in the maintenance mode. The category of resources may specify the dependency relationship with the resource. For example, the selected category of resources may include descendants of the resource, ancestors of the resource, peers of resource-type associated with the resource, or any combination thereof.

During the maintenance schedule of the resource, instructions 710 may be executed by processor 702 to mark that the resource and the determined set of resources are in a maintenance mode. Further, computer-readable storage medium 704 may store instructions to update an interface to indicate that the determined set of resources are in the maintenance mode. For example, the interface includes a user interface, an application programming interface (API), and a Representational State Transfer (REST) API, or any combination thereof. In another example, the user interface may include a Web browser.

Upon marking the resource and the determined set of resources, instructions 712 may be executed by processor 702 to suspend monitoring of the resource and the determined set of resources having the dependency relationship with the resource. In an example, instructions 712 to suspend monitoring of the resource and the determined set of resources may include instructions to suspend computation of health, alerts, troubleshooting workbench, reports, and predefined dashboards for the resource and the determined set of resources.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. A management node comprising:
a processor; and
memory coupled to the processor, wherein the memory comprises a resource management module to:
determine a maintenance schedule of a resource in a data center;
prior to the resource entering the maintenance schedule, determine a set of resources having a dependency relationship with the resource based on a preselected category; and
during the maintenance schedule of the resource:
mark that the resource and the set of resources having the dependency relationship with the resource are in a maintenance mode; and
upon marking the resource and the set of resources, suspend monitoring of the resource and the set of resources.

2. The management node of claim 1, wherein the resource management module is to:
receive, via an interface, a selection of an option specifying the preselected category of resources to be placed in the maintenance mode, wherein the preselected category of resources is to specify the dependency relationship with the resource.

3. The management node of claim 1, wherein the resource comprises one of an infrastructure element and a business application.

4. The management node of claim 3, when the resource is the infrastructure element, the resource management module is to determine the set of resources that are descendants of the resource, ancestors of the resource, peers of a resource-type associated with the resource, or any combination thereof based on the preselected category.

5. The management node of claim 3, when the resource is the business application, the resource management module is to determine the set of resources that are descendants of the resource, ancestors of the resource, or both based on the preselected category.

6. The management node of claim 1, wherein the resource management module is to:
suspend computation of health, alerts, troubleshooting workbench, reports, and predefined dashboards for the resource and the determined set of resources.

7. The management node of claim 1, wherein the resource management module is to:
update an interface to indicate that the resource and the determined set of resources are in the maintenance mode, wherein the interface includes a user interface, an application programming interface (API), and a Representational State Transfer (REST) API, or any combination thereof, and wherein the user interface includes a Web browser.

8. A method comprising:
receiving, via an interface, a selection of an option defining a category of resources to be placed in a maintenance mode, wherein the category of resources is to specify a dependency relationship with a resource in a data center; and
during a scheduled maintenance of the resource:
determining a set of resources having the dependency relationship with the resource based on the selected option;
marking the resource and the determined set of resources as in a maintenance mode; and
upon marking the resource and the determined set of resources, suspending monitoring of the resource and the determined set of resources having the dependency relationship with the resource.

9. The method of claim 8, wherein the category of resources comprises descendants of the resource, ancestors of the resource, peers of resource-type associated with the resource, or any combination thereof.

10. The method of claim 8, wherein suspending monitoring of the resource and the determined set of resources comprises:
suspending computation of health, alerts, troubleshooting workbench, reports, and predefined dashboards for the resource and the determined set of resources.

11. The method of claim 8, wherein suspending monitoring of the resource and the determined set of resources comprises:
suspending monitoring of the resource and the determined set of resources to avoid generating false positive alerts during the scheduled maintenance.

12. The method of claim 8, further comprising:
updating the interface to indicate that the resource and the determined set of resources are in the maintenance mode, wherein the interface includes a user interface, an application programming interface (API), and a Representational State Transfer (REST) API, or any combination thereof, and wherein the user interface includes a Web browser.

13. The method of claim 8, wherein the resource comprises an infrastructure element in a data center, and wherein the set of resources comprises at least one virtual machine running on a physical host computing system and at least one application running on the at least one virtual machine.

14. The method of claim 8, wherein the resource comprises a business application, and wherein the set of resources comprises components of the business application that provide a business functionality.

15. A non-transitory computer-readable storage medium having instructions executable by a processor of a management node to:
determine that a resource in a data center is entering a maintenance schedule;
determine a set of resources having a dependency relationship with the resource based on a selected category; and
during the maintenance schedule of the resource:
mark that the resource and the determined set of resources are in a maintenance mode; and
upon marking the resource and the determined set of resources, suspend monitoring of the resource and the determined set of resources having the dependency relationship with the resource.

16. The non-transitory computer-readable storage medium of claim 15, further comprising instructions to:
receive, via an interface, a selection of a category of resources to be placed in the maintenance mode, wherein the category of resources is to specify the dependency relationship with the resource.

17. The non-transitory computer-readable storage medium of claim 15, wherein the selected category of resources comprises descendants of the resource, ancestors of the resource, peers of resource-type associated with the resource, or any combination thereof.

18. The non-transitory computer-readable storage medium of claim 15, wherein instructions to suspend monitoring of the resource and the determined set of resources comprise instructions to:
suspend computation of health, alerts, troubleshooting workbench, reports, and predefined dashboards for the resource and the determined set of resources.

19. The non-transitory computer-readable storage medium of claim 15, further comprising instructions to:
update an interface to indicate that the determined set of resources are in the maintenance mode, wherein the interface includes a user interface, an application programming interface (API), and a Representational State Transfer (REST) API, or any combination thereof, and wherein the user interface includes a Web browser.

20. The non-transitory computer-readable storage medium of claim 15, wherein the resource comprises one of an infrastructure element and a business application.
